(19) United States
(12) Patent Application Publication
(10) Pub. No.: US 2012/0317829 A1
(43) Pub. Date: Dec. 20, 2012

(54) HAIR DRYER SYSTEM

(76) Inventor: YONG TOK KIM, RIVERVIEW, FL (US)

(21) Appl. No.: 13/349,257

(22) Filed: Jan. 12, 2012

Related U.S. Application Data
(60) Provisional application No. 61/520,749, filed on Jun. 14, 2011.
(60) Provisional application No. 61/627,376, filed on Oct. 11, 2011.

(51) Int. Cl. A45D 20/04; F26B 21/06

(52) U.S. Cl. 34/82; 34/101; 34/98; 34/72

(57) ABSTRACT

A housing is provided in a generally rectilinear configuration. The housing has input and output openings. The housing has upper and lower and side walls. Primary and secondary chambers are formed between the walls. The primary chamber is positioned between the input and output openings. A plurality of supports are provided within the primary chamber for receiving and supporting portions of the hair of the user. The upper wall has first and second sections. The first section is imperforate and adapted to provide access to the primary chamber. The second section has a plurality of aligned circular apertures over the secondary chamber for removably receiving a blow dryer.

### RELATED APPLICATION

The present application is based upon Provisional Application No. 61/520,749 filed Jun. 14, 2011, the subject matter of which is incorporated herein by reference.

### BACKGROUND OF THE INVENTION

### Field of the Invention

The present invention relates to a hair dryer system and more particularly pertains to blow drying, and optionally scenting, hair of a user, the blow drying and scenting being done in a rapid, safe, comfortable, convenient and economical manner.

### SUMMARY OF THE INVENTION

In view of the foregoing disadvantages inherent in the known types of hair dryer systems of known designs and configurations now present in the prior art, the present invention provides an improved hair dryer system. As such, the general purpose of the present invention, which will be described subsequently in greater detail, is to provide a new and improved hair dryer system and method which has all the advantages of the prior art and none of the disadvantages.

To attain this, the present invention essentially comprises a hair dryer system. First provided is a housing. The housing is in a generally rectilinear configuration. The housing has an input wall. The input wall has an input opening. The housing has an output wall. The output wall has an output opening. The housing has a horizontal upper wall. The housing has a parallel lower wall. The housing has vertical first and second side walls. The side walls couple the upper and lower walls. The side walls couple the input and output walls.

A primary chamber is provided. A secondary chamber is provided. The secondary chamber is operatively coupled to the primary chamber. The secondary chamber is formed between the walls. The primary chamber is positioned between the input and output openings. The secondary chamber is smaller than the primary chamber. The secondary chamber is laterally offset from the primary chamber.

A support post has an upper end. The upper end of the support post is coupled to a central extent of the lower wall. The support post has a lower end. The support post has a plurality of wheels. In this manner the re-positioning of the housing is facilitated.

A plurality of ladder-shaped supports is provided. The ladder-shaped supports are provided within the primary chamber. The ladder-shaped supports are positioned horizontally. The ladder-shaped supports are positioned one upon another. In this manner a portion of the hair of the user is received and supported. The ladder-shaped supports include a lowermost support. The lowermost support is provided in a treadmill-like configuration. The lowermost support has a transverse iron. The transverse iron is movable from the input opening to the output opening. In this manner the hair of a user is smoothed. The lowermost support has a transverse comb. The transverse comb is movable from the input opening to the output opening. In this manner the hair of a user is combed out.

A drive box is provided next. The drive box is secured to the output wall adjacent to the secondary chamber. The drive box is operatively coupled to the lowermost support. In this manner movement of the iron and the comb is facilitated.

Further provided is a moisture and scent filter. The filter is secured to the output opening adjacent to the primary chamber. A fan is provided. The fan is secured to the output opening adjacent to the moisture and scent filter. The fan is adapted to facilitate movement of air through the secondary and primary chambers.

The upper wall has a first section. The upper wall also has a second section. The first section is imperforate. The first section is adapted to provide access to the primary chamber for positioning the ladder-shaped supports and the hair of the user upon the ladder-shaped supports. The second section has a plurality of aligned circular apertures. The apertures are provided over the secondary chamber.

Provided last is a blower assembly. The blower assembly includes a plurality of blow dryers. The blow dryers have exhaust ends. The exhaust ends are positionable in the apertures of the upper wall. In this manner a flow of heated air is provided through the secondary and primary chambers. Further in this manner the hair on the ladder-shaped supports is dried. Optional components include cylindrical plugs. Optional components also include individual hair dryers. The individual hair dryers have transition sleeves. The transition sleeves are positionable in the apertures of the upper wall instead of the blower assembly. The blower assembly also includes a removable air freshener. The blower assembly also includes an electrical panel. The electrical panel includes an ON/OFF switch. The electrical panel also includes electrical outlets. The electrical panel further includes a rheostat. Lastly, the electrical panel includes a circuit breaker.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved hair dryer system which has all of the advantages of the prior art hair dryer systems of known designs and configurations and none of the disadvantages.

It is another object of the present invention to provide a new and improved hair dryer system which may be easily and efficiently manufactured and marketed.

It is further object of the present invention to provide a new and improved hair dryer system which is of durable and reliable constructions.

An even further object of the present invention is to provide a new and improved hair dryer system which is susceptible of a low cost of manufacture with regard to both materials and labor, and which accordingly is then susceptible of low prices of sale to the consuming public, thereby making such hair dryer system economically available to the buying public.

Even still another object of the present invention is to provide a hair dryer system for blow drying, and optionally scenting, hair of a user, the blow drying and scenting being done in a rapid, safe, comfortable, convenient and economical manner.

Lastly, it is an object of the present invention to provide a new and improved hair dryer system. A housing is provided in a generally rectilinear configuration. The housing has input and output openings. The housing has upper and lower and side walls. Primary and secondary chambers are formed between the walls. The primary chamber is positioned between the input and output openings. A plurality of supports are provided within the primary chamber for receiving and supporting portions of the hair of the user. The upper wall has first and second sections. The first section is imperforate and adapted to provide access to the primary chamber. The second section has a plurality of aligned circular apertures over the secondary chamber for removably receiving a blow dryer.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is perspective illustration of a of a hair dryer system constructed in accordance with the principles of the present invention.

FIG. 2 is a side elevational view taken along line 2-2 f FIG. 1.

FIG. 3 is an exploded perspective illustration of the system shown in FIGS. 1 and 2.

FIG. 4 is a partially exploded perspective illustration similar to FIG. 1 but with the system in use.

FIG. 5 is an exploded perspective illustration of a system constructed in accordance with an alternate embodiment of the invention.

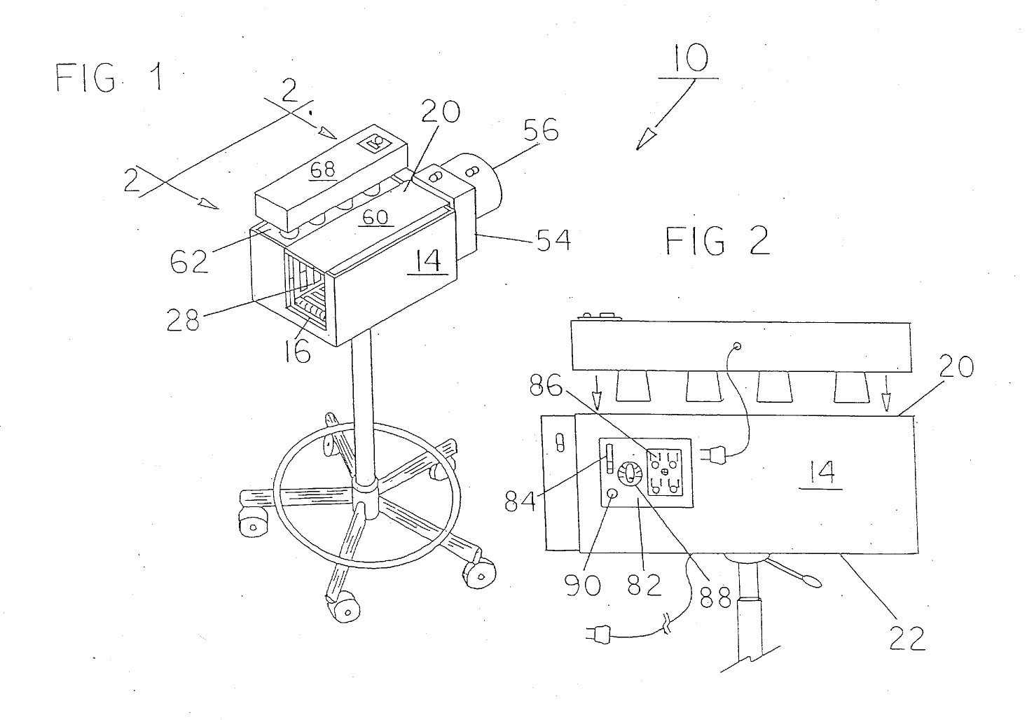

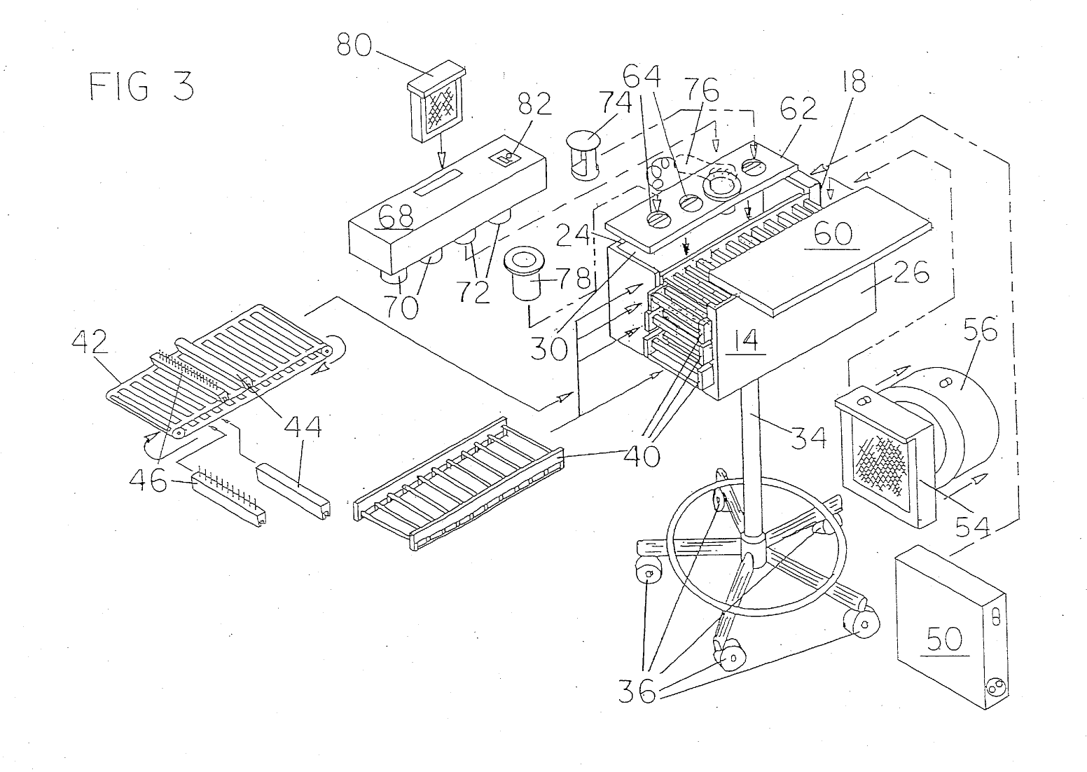

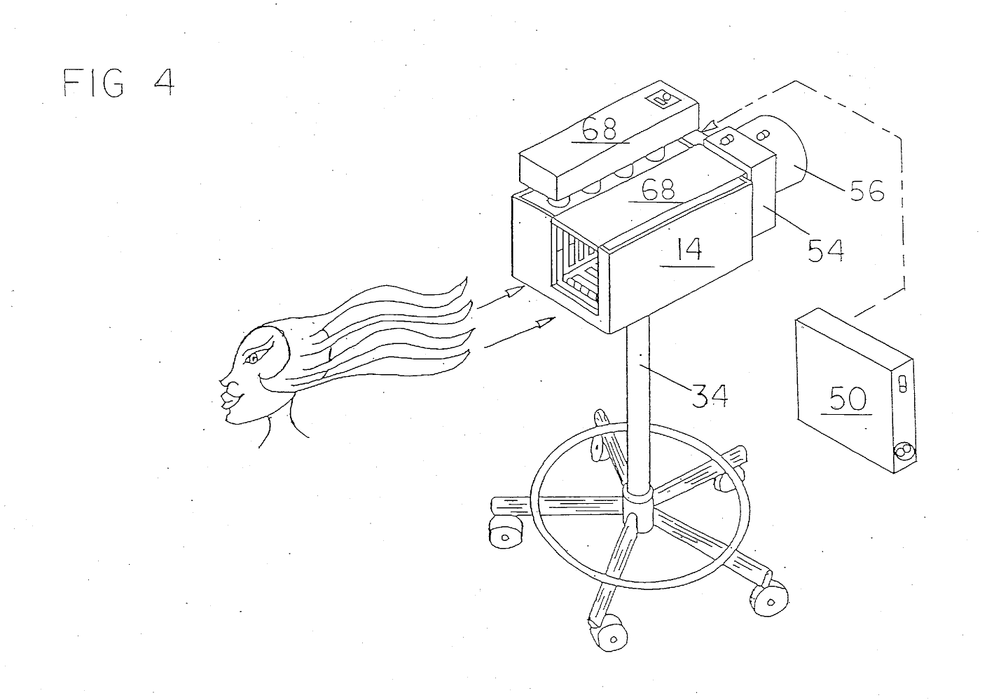

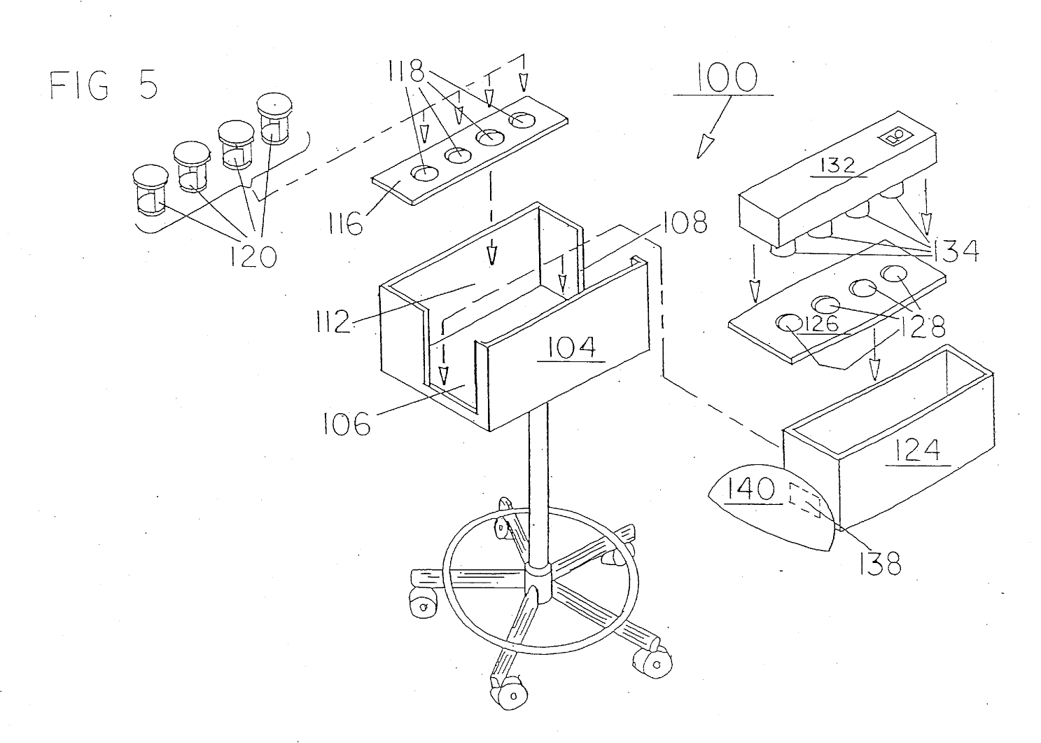

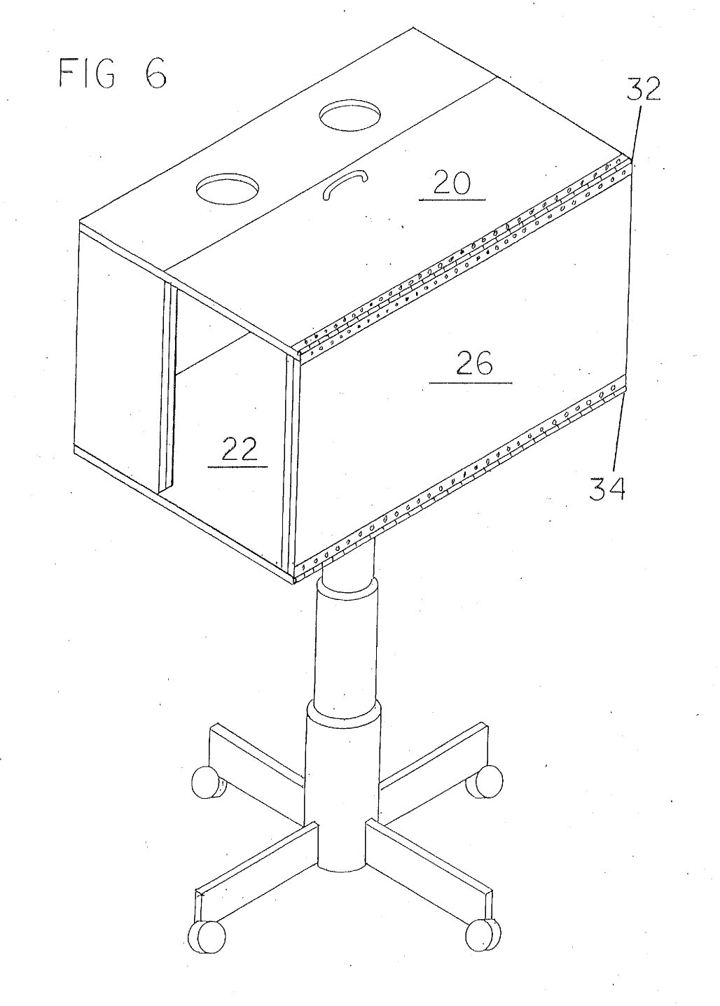

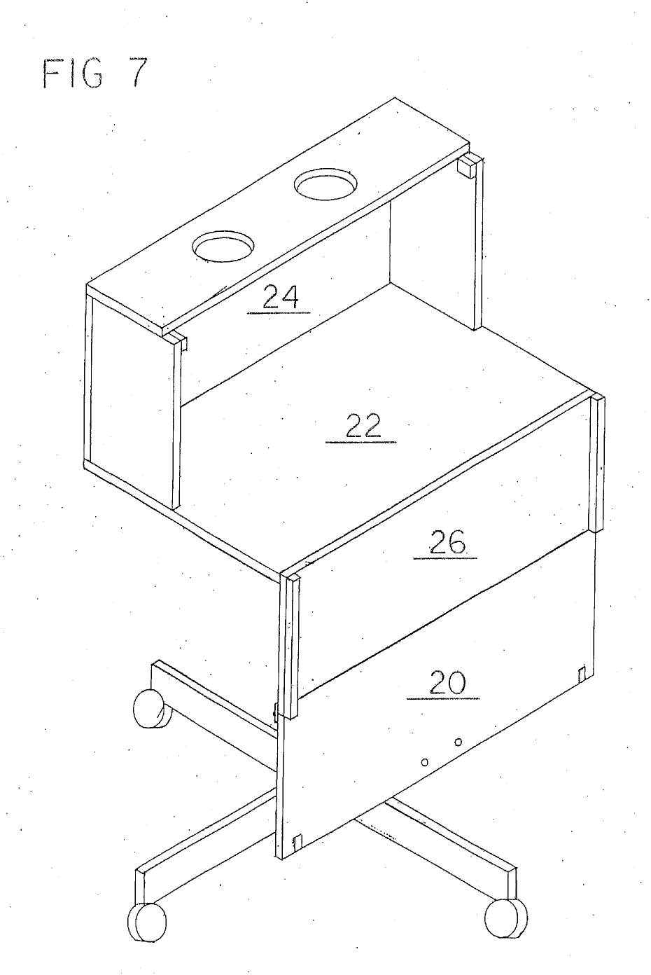

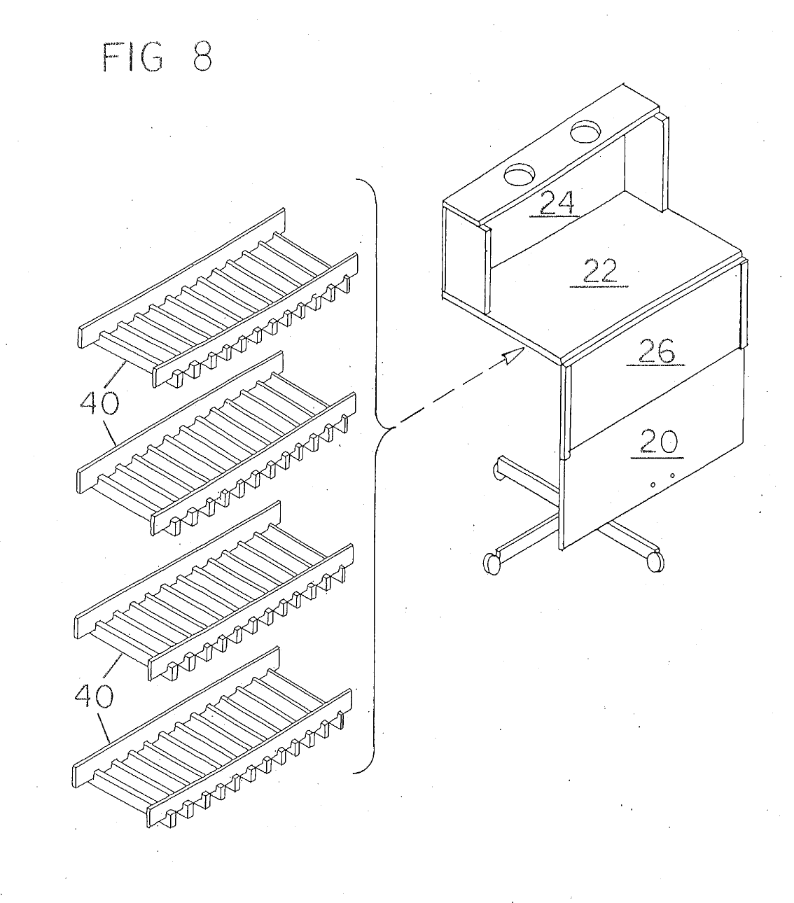

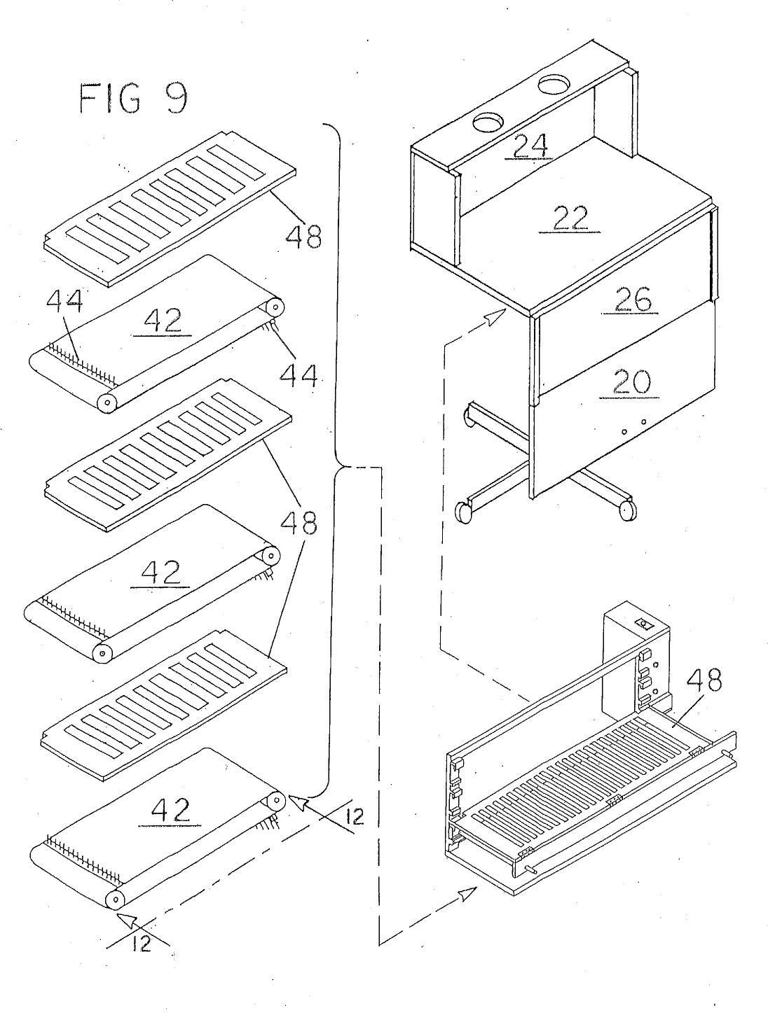

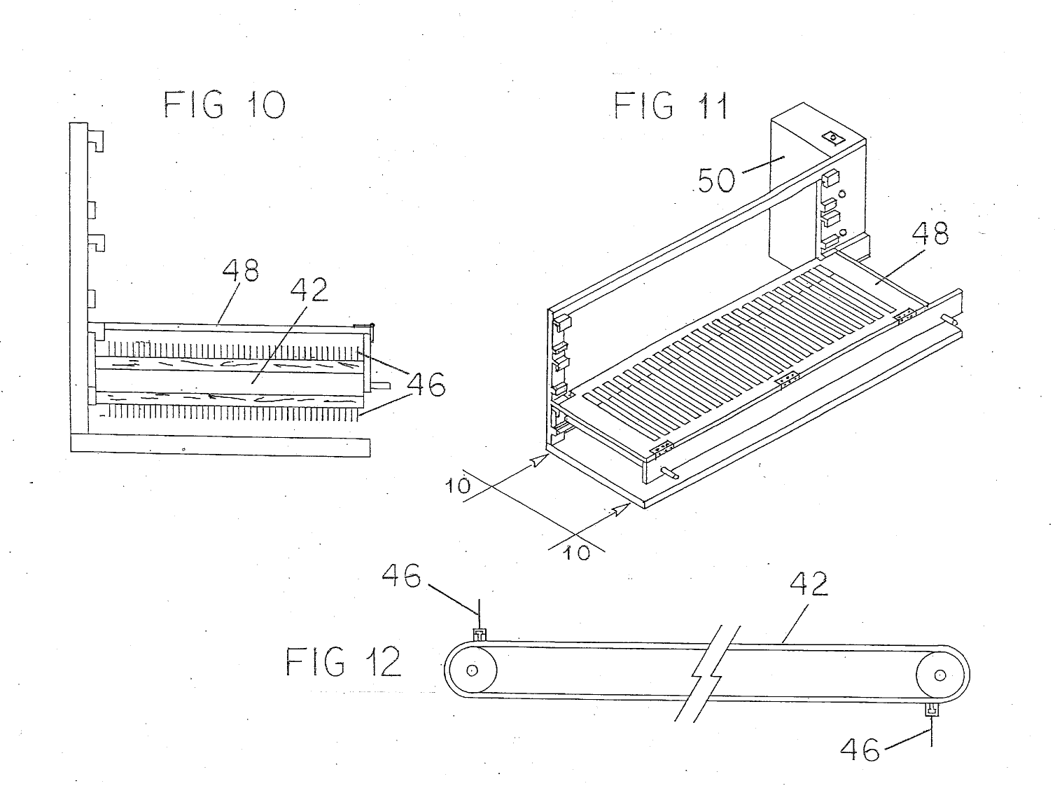

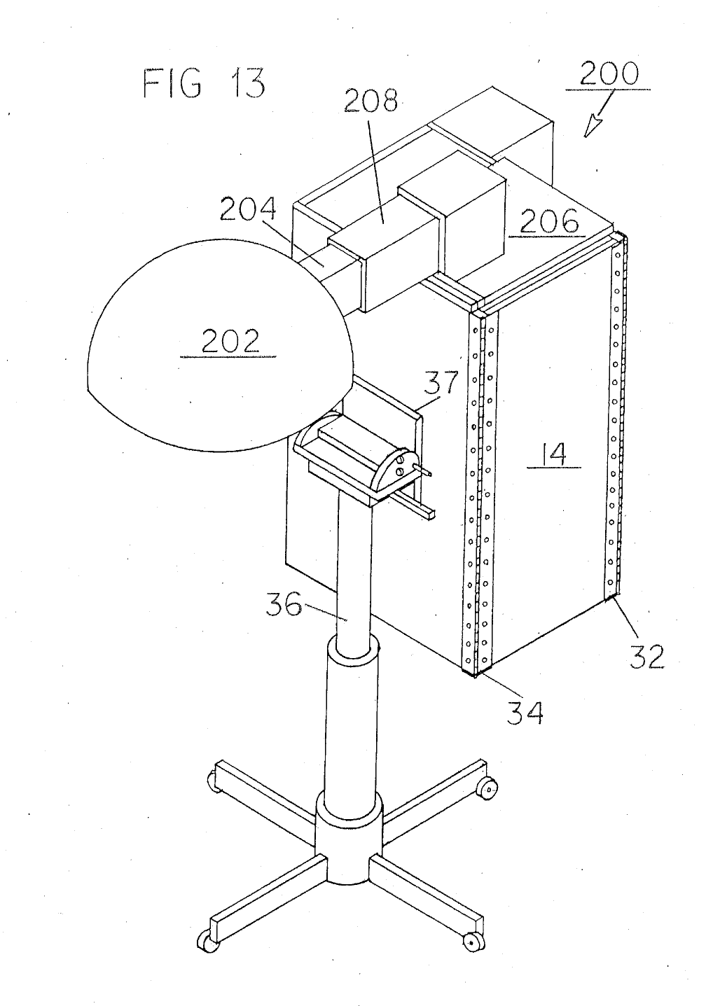

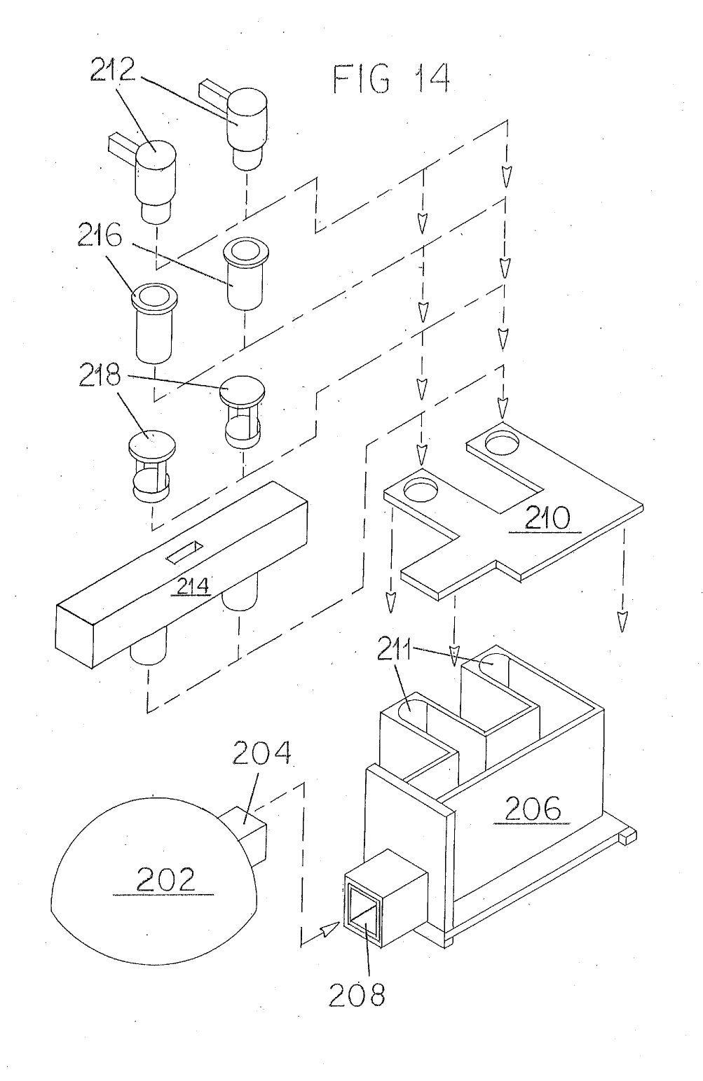

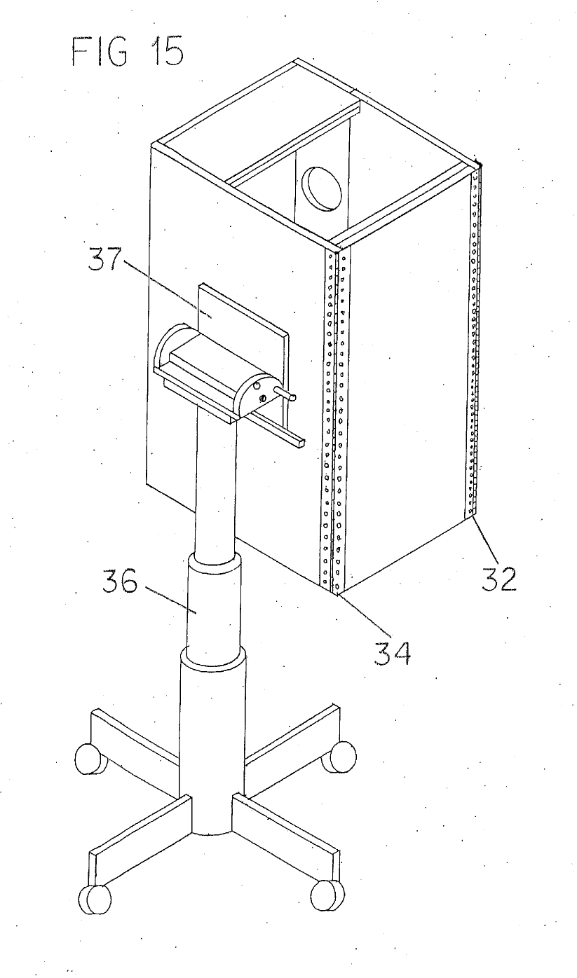

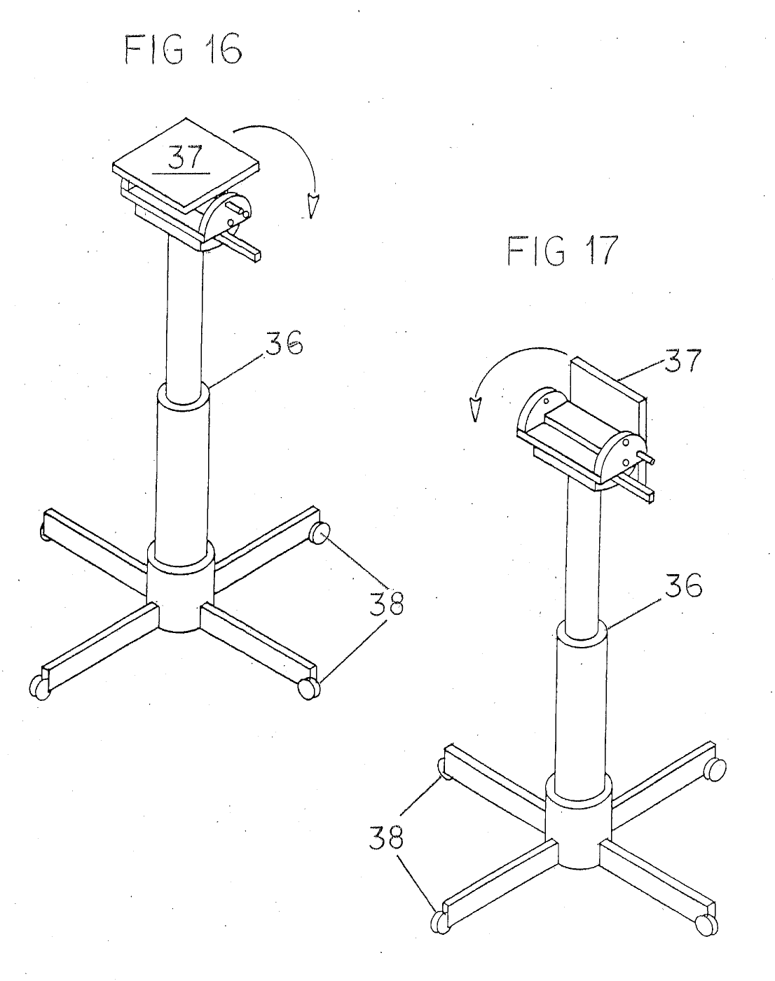

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved hair dryer system embodying the principles and concepts of the present invention and generally designated by the reference numeral 10 will be described.

The present invention, the hair dryer system 10 is comprised of a plurality of components. Such components in their broadest context include a housing and a plurality of supports. Such components are individually configured and correlated with respect to each other so as to attain the desired objective.

First provided is a housing 14. The housing is in a generally rectilinear configuration. The housing has an input wall. The input wall has an input opening 16. The housing has an output wall. The output wall has an output opening 18. The housing has a horizontal upper wall 20. The housing has a parallel lower wall 22. The housing has vertical first and second side walls 24, 26. The side walls couple the upper and lower walls. The side walls couple the input and output walls.

A primary chamber 28 is provided. A secondary chamber 30 is provided. The secondary chamber is operatively coupled to the primary chamber. The secondary chamber is formed between the walls. The primary chamber is positioned between the input and output openings. The secondary chamber is smaller than the primary chamber. The secondary chamber is laterally offset from the primary chamber.

A support post 34 has an upper end. The upper end of the support post is coupled to a central extent of the lower wall. The support post has a lower end. The support post has a plurality of wheels 36. In this manner the re-positioning of the housing is facilitated.

A plurality of ladder-shaped supports 40 is provided. The ladder-shaped supports are provided within the primary chamber. The ladder-shaped supports are positioned horizontally. The ladder-shaped supports are positioned one upon another. In this manner a portion of the hair of the user is received and supported. The ladder-shaped supports include a lowermost support 42. The lowermost support is provided in a treadmill-like configuration. The lowermost support has a transverse iron 44. The transverse iron is movable from the input opening to the output opening. In this manner the hair of a user is smoothed. The lowermost support has a transverse comb 46. The transverse comb is movable from the input opening to the output opening. In this manner the hair of a user is combed out.

A drive box 50 is provided next. The drive box is secured to the output wall adjacent to the secondary chamber. The drive box is operatively coupled to the lowermost support. In this manner movement of the iron and the comb is facilitated.

Further provided is a moisture and scent filter 54. The filter is secured to the output opening adjacent to the primary chamber. A fan 56 is provided. The fan is secured to the output opening adjacent to the moisture and scent filter. The fan is adapted to facilitate movement of air through the secondary and primary chambers.

The upper wall has a first section 60. The upper wall also has a second section 62. The first section is imperforate. The first section is adapted to provide access to the primary chamber for positioning the ladder-shaped supports and the hair of the user upon the ladder-shaped supports. The second section has a plurality of aligned circular apertures 64. The apertures are provided over the secondary chamber.

Provided last is a blower assembly 68. The blower assembly includes a plurality of blow dryers 70. The blow dryers have exhaust ends 72. The exhaust ends are positionable in the apertures of the upper wall. In this manner a flow of heated air is provided through the secondary and primary chambers. Further in this manner the hair on the ladder-shaped supports is dried. Optional components include cylindrical plugs 74. Optional components also include individual hair dryers 76. The individual hair dryers have transition sleeves 78. The transition sleeves are positionable in the apertures of the upper wall instead of the blower assembly. The blower assembly also includes a removable air freshener 80. The blower assembly also includes an electrical panel 82. The electrical panel includes an ON/OFF switch 84. The electrical panel also includes electrical outlets 86. The electrical panel further includes a rheostat 88. Lastly, the electrical panel includes a circuit breaker 90.

An alternate embodiment 100 of the present invention is provided. A housing 104 is provided. The housing is in a generally rectilinear configuration. The housing has an input opening 106. The housing has output opening 108. The housing has upper and lower and side walls. A primary chamber 110 is provided. A secondary chamber 112 is also provided. The secondary chamber is formed between the walls. The primary chamber is positioned between the input and output openings.

A secondary cover plate 116 is provided. The secondary cover plate has aligned secondary apertures 118. The apertures have cylindrical plugs 120. The plugs are positioned within the secondary apertures.

A container 124 is provided. The container is provided within the primary chamber. The container has an open top. The container has a primary cover plate 126. The primary cover plate has aligned primary apertures 128.

A blower assembly 132 is provided. The blower assembly has a plurality of blow dryers. The blow dryers have exhaust ends 134. The exhaust ends are positionable in the primary apertures of the upper wall. In this manner a flow of heated air is provided.

Provided last is a cut-out 138. The cut-out is provided in the container adjacent to the output end of the housing. A hemispherical bowl 140 is provided. The bowl is operatively coupled to the container through the cut-out and the output end. The bowl is adapted to receive hair of a user wherein such hair is short. The flow of heated blower assembly is adapted to dry short hair within the bowl.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A hair dryer system comprising:
a housing in a generally rectilinear configuration, the housing having input and output openings, the housing having upper and lower and side walls, primary and secondary chambers formed between the walls, the primary chamber being positioned between the input and output openings;
a plurality of supports within the primary chamber for receiving and supporting portions of the hair of the user; and
the upper wall being formed of first and second sections, the first section being imperforate and adapted to provide access to the primary chamber, the second section formed with a plurality of aligned circular apertures over the secondary chamber for removably receiving a blow dryer.

2. The system as set forth in claim 1 and further including:
a blower assembly having a plurality of blow dryers, the blow dryers having exhaust ends positionable in the apertures of the upper wall for providing a flow of heated air through the secondary and primary chambers to dry the hair on the ladder-shaped supports.

3. The system as set forth in claim 2 and further including:
optional components including cylindrical blocks and individual hair dryers with transition sleeves positionable in the apertures of the upper wall instead of the blower assembly.

4. The system as set forth in claim 2 wherein the blower assembly also includes a removable air freshener.

5. The system as set forth in claim 2 wherein the blower assembly also includes an electrical panel, the electrical panel including an ON/OFF switch and electrical outlets and a rheostat and a circuit breaker.

6. The system as set forth in claim 1 and further including:
a support post having an upper end coupled to a central extent of the lower wall, the support post having a lower end with a plurality of wheels for facilitating the re-positioning of the housing.

7. The system as set forth in claim 1 wherein the supports include plurality of ladder-shaped supports within the primary chamber, the ladder-shaped supports positioned horizontally, one upon another for receiving and supporting a portion of the hair of the user.

8. The system as set forth in claim 7 wherein the ladder-shaped supports include a lowermost support in a treadmill-like configuration having a transverse iron movable from the input opening to the output opening to smooth the hair of a user, the lowermost support having a transverse comb movable from the input opening to the output opening to comb out the hair of a user.

9. The system as set forth in claim 1 and further including:
a moisture and scent filter secured to the output opening adjacent to the primary chamber, a fan secured to the output opening adjacent to the moisture and scent filter adapted to facilitate movement of air through the secondary and primary chambers.

10. A hair dryer system (100) comprising:
a housing (104) in a generally rectilinear configuration, the housing having an input opening (106) and output opening (108), the housing having upper and lower and side walls, a primary chamber (110) and a secondary chamber (112) formed between the walls, the primary chamber being positioned between the input and output openings;
a secondary cover plate (116) with aligned secondary apertures (118) with cylindrical plugs (120) positioned within the secondary apertures;
a container (124) within the primary chamber, the container having an open top with a primary cover plate (126), the primary cover plate having aligned primary apertures (128);
a blower assembly (132) having a plurality of blow dryers, the blow dryers having exhaust ends (134) positionable in the primary apertures of the upper wall for providing a flow of heated air; and
a cut-out (138) in the container adjacent to the output end of the housing, a hemispherical bowl (140) operatively coupled to the container through the cut-out and the output end, the bowl adapted to receive hair of a user wherein such hair is short, the flow of heated blower assembly adapted to dry short hair within the bowl.

11. A hair dryer system (10) for blow drying, and optionally scenting, hair of a user, the blow drying and scenting being done in a rapid, safe, comfortable, convenient and economical manner, the system comprising, in combination:
a housing (14) in a generally rectilinear configuration, the housing having an input wall with an input opening (16) and an output wall with an output opening (18), the housing having a horizontal upper wall (20) and a parallel lower wall (22), the housing having vertical first and second side walls (24), (26), the side walls coupling the upper and lower walls, the side walls coupling the input and output walls, a primary chamber (28) and an operatively coupled secondary chamber (30) formed between the walls, the primary chamber being positioned between the input and output openings, the secondary chamber being smaller than and laterally offset from the primary chamber;
a support post (34) having an upper end coupled to a central extent of the lower wall, the support post having a lower end with a plurality of wheels (36) for facilitating the re-positioning of the housing;
a plurality of ladder-shaped supports (40) within the primary chamber, the ladder-shaped supports positioned horizontally, one upon another for receiving and supporting a portion of the hair of the user, the ladder-shaped supports including a lowermost support (42) in a treadmill-like configuration having a transverse iron (44) movable from the input opening to the output opening to smooth the hair of a user, the lowermost support having a transverse comb (46) movable from the input opening to the output opening to comb out the hair of a user;
a drive box (50) secured to the output wall adjacent to the secondary chamber, the drive box operatively coupled to the lowermost support to facilitate movement of the iron and the comb;
a moisture and scent filter (54) secured to the output opening adjacent to the primary chamber, a fan (56) secured to the output opening adjacent to the moisture and scent filter adapted to facilitate movement of air through the secondary and primary chambers;
the upper wall being formed of a first section (60) and a second section (62), the first section being imperforate and adapted to provide access to the primary chamber for positioning the ladder-shaped supports and the hair of the user upon the ladder-shaped supports, the second section formed with a plurality of aligned circular apertures (64) over the secondary chamber; and
a blower assembly (68) having a plurality of blow dryers (70), the blow dryers having exhaust ends (72) positionable in the apertures of the upper wall for providing a flow of heated air through the secondary and primary chambers to dry the hair on the ladder-shaped supports, optional components including cylindrical plugs (74) and individual hair dryers (76) with transition sleeves (78) positionable in the apertures of the upper wall instead of the blower assembly, the blower assembly also including a removable air freshener (80), the blower assembly also including an electrical panel (82), the electrical panel including an ON/OFF switch (84) and electrical outlets (86), a rheostat (88) and a circuit breaker (90).
